(19) United States
(12) Patent Application Publication
(10) Pub. No.: US 2014/0237901 A1
(43) Pub. Date: Aug. 28, 2014

(54) LINEAR CENTER RAIL LINK STRUCTURE OF SLIDING DOOR FOR VEHICLE

(71) Applicant: Hyundai Motor Company, Seoul (KR)

(72) Inventors: Young Jin KWON, Seoul (KR); Hyung In YUN, Incheon (KR)

(21) Appl. No.: 13/914,335

(22) Filed: Jun. 10, 2013

(30) Foreign Application Priority Data
Feb. 27, 2013 (KR) 10-2013-0021059

(51) Int. Cl. E05D 15/06; B60J 5/06; E05B 83/04; E06B 3/46

(52) U.S. Cl. CPC E05D 15/0621; E06B 3/4636; B60J 5/06; E05B 83/04
USPC 49/449

(57) ABSTRACT

Disclosed is a linear center rail link structure of sliding door for vehicle, the linear center rail link structure includes linear-shaped center rail mounted on side of car body corresponding to sliding door of vehicle and having striker formed at predetermined position in vertical direction. A base is configured to be moveable in length direction along center rail. A link arm has one end rotatably inserted into base. A slider rotatably connected to other end of link arm has outer side surface coupled to sliding door. A rotatable latch part provided at base is locked or unlocked from striker. Therefore, indoor invasion amount of center rail is minimized, thereby making possible securing indoor space. The linear center rail is used, thereby making possible improvement of design of vehicle. In addition, a link structure is provided, thereby making possible improving of operability of opening and closing of sliding door.

### CROSS-REFERENCE TO RELATED APPLICATION

This application is based on and claims priority from Korean Patent Application No. 10-2013-0021059, filed on Feb. 27, 2013 in the Korean Intellectual Property Office, the disclosure of which is incorporated herein in its entirety by reference.

### TECHNICAL FIELD

The present disclosure relates to a linear center rail link structure of a sliding door for a vehicle, and more particularly, to a linear center rail link structure of a sliding door for a vehicle for decreasing an indoor invasion amount of a center rail curved part of the sliding door and improving operability of opening and closing of the sliding door.

### BACKGROUND

Generally, a side of a car body of a small van is installed with a sliding door that may be opened and closed in a sliding scheme so that passengers may get in or get out of the small van.

In addition, a central point and a lower point of the sliding door are installed with a center roller and a lower roller, respectively. The center roller and the lower roller are inserted into a rail installed at the car body, respectively, to be rolled along the rail, such that they are slid with respect to the car body.

Meanwhile, a power sliding door has been used that automatically opens or closes by operating a switch.

In addition, the power sliding door has a structure in which it is automatically opened or closed using a driving apparatus such as a motor or a cylinder and several power transfer units such as a cable, a belt, a pulley, and a gear and includes an electrical control unit (ECU) controlling an operation of the driving apparatus together with a door switch.

In addition, as shown in FIG. 1, a driving apparatus 1 of a power sliding door disclosed in Korean Patent No. 10-0558413 has a structure of moving a cable 5 connected to a front pulley 3 and a rear pulley 4 each disposed at front and rear end portions of a center rail 2 mounted on a car body to move a center roller 6 mounted at and fixed to the cable 5.

Further, the driving apparatus 1 includes a support bracket 10 mounted at and fixed to a door panel of the sliding door; a roller bracket 20 mounted at the support bracket 10 and including a roller 21 (see FIG. 2) coupled to the center rail 2 of the car body to thereby be rolled; a barrel 30 fixed to the roller bracket 20 and having the cable 5 penetrating therethrough and fixed thereto, the cable 5 being moved by the center roller 6, and a fixing bracket 40 fixing the barrel 30 to the roller bracket 20.

That is, the cable 5 connected to the driving apparatus 1 through the front pulley 3 and the rear pulley 4 is moved by an operation of the driving apparatus 1, and the center roller 6 is moved along the center rail 2 together with the movement of the cable 5 to open or close the sliding door.

Meanwhile, the fixing bracket 40 is coupled and fixed to the roller bracket 20 by a bearing 22 formed at a central portion and includes hook parts 40a formed at both ends thereof and bent in a hook shape, wherein the hook parts 40a fix the barrel 30 while enclosing the barrel 30 in two directions in which the cable 5 is moved, as shown in FIG. 2.

However, according to the related art, since the center rail of the sliding door has a curved shape as shown at A of FIG. 1, the indoor invasion amount is excessive, such that a space inside the car is decreased. In addition, an operation force of a door handle is dispersed, such that an operating force is deteriorated when opening or closing the sliding door.

### SUMMARY

Accordingly, the present disclosure has been made to solve the above-mentioned problems occurring in the prior art while advantages achieved by the prior art are maintained intact.

One achievement of the present disclosure is to provide a linear center rail link structure of a sliding door for a vehicle to reduce an indoor invasion amount of a center rail curved part of the sliding door and improve operability of opening and closing of the sliding door.

In one aspect of the present disclosure, there is provided a linear center rail link structure of a sliding door for a vehicle. The linear center rail link structure includes a linear-shaped center rail mounted at a side of a car body to corresponding to the sliding door of the vehicle and having a striker formed at a predetermined position in a vertical direction. A base is configured to be moveable in a length direction along the center rail. A link arm has one end rotatably inserted into the base. A slider is rotatably connected to the other end of the link arm and has an outer side surface coupled to the sliding door. A rotatable latch part is provided at the base to be locked to or unlocked from the striker.

The slider may include an outer side slider coupled to the sliding door, and an inner side slider slidably provided in the outer side slider by a predetermined length and rotatably coupled to an other end of the link arm.

The latch part may include a pawl rotatably provided at the base to be locked to or unlocked from the link arm, and a claw rotatably provided at the base to be locked to or unlocked from the striker. The pawl may have a lock protrusion formed at one end thereof to be selectively locked to or unlocked from the link arm, and one end of the claw may be provided with a lock groove so as to be locked to or unlocked from the striker and the other end of the claw may be locked to the pawl so as to be rotatable. An other end of the pawl may be provided with a first locking part and the other end of the claw may be provided with a second locking part locked to or unlocked from the first locking part.

A lower portion of one end of the link arm, locked to or unlocked from the lock protrusion of the pawl, may be provided with a protrusion part.

An upper outer side of the base may be provided with a roller.

The rotation of the pawl and the claw may be elastically supported by springs.

### BRIEF DESCRIPTION OF THE DRAWINGS

The above and other objects, features and advantages of the present disclosure will be more apparent from the following detailed description taken in conjunction with the accompanying drawings, in which:

FIGS. 1 and 2 are views showing a structure of a sliding door according to the related art;

FIG. 3 is a view showing a linear center rail link structure of a sliding door for a vehicle according to an exemplary embodiment of the present disclosure;

FIG. 4 is an exploded perspective view showing the linear center rail link structure of a sliding door for a vehicle according to the exemplary embodiment of the present disclosure;

FIGS. 5 and 6 are views showing latch parts of the linear center rail link structure of a sliding door for a vehicle according to the exemplary embodiment of the present disclosure;

FIGS. 7A, 7B, 8A, 8B, 9A, and 9B are views showing an open state of the linear center rail link structure of a sliding door for a vehicle according to the exemplary embodiment of the present disclosure; and

FIGS. 10A, 10B, and 10C are views showing a state of the latch part at the time of opening the sliding door in the linear center rail link structure of a sliding door for a vehicle according to the exemplary embodiment of the present disclosure.

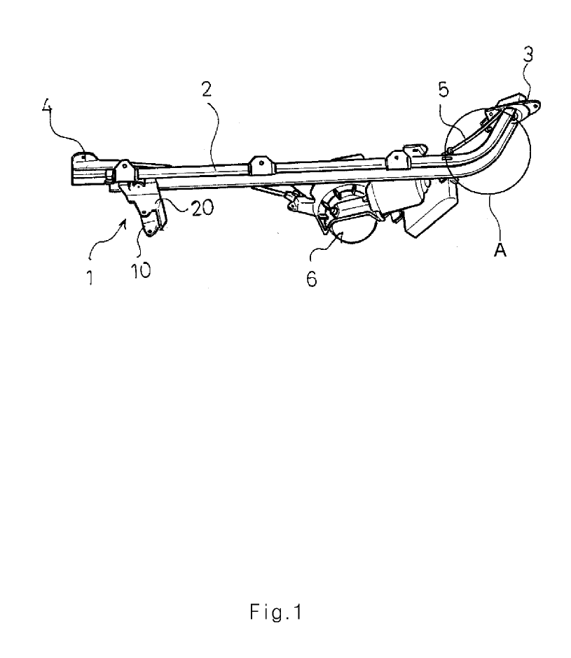

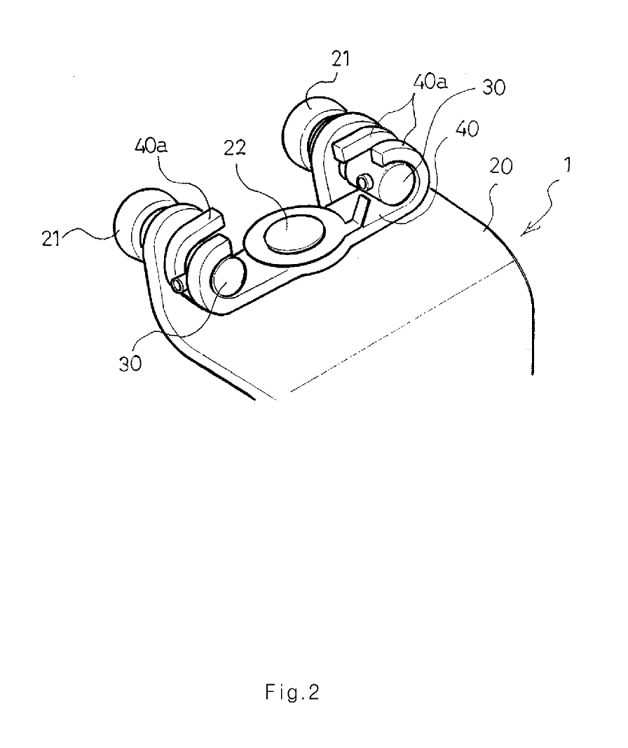

### DETAILED DESCRIPTION

Exemplary embodiments of the present disclosure will be described in detail with reference to the accompanying drawings.

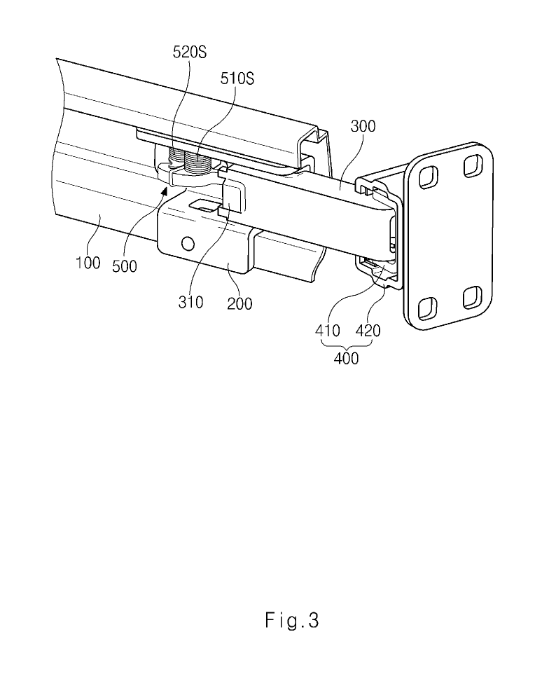

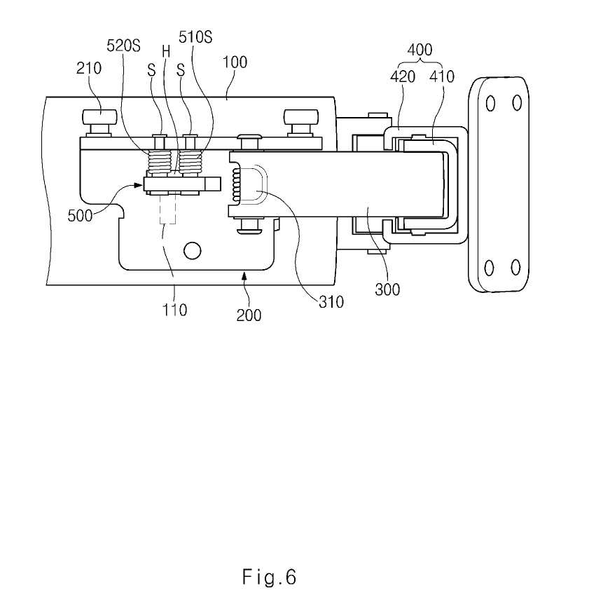

A linear center rail link structure of a sliding door for a vehicle according to an exemplary embodiment of the present disclosure is configured to include a center rail 100 mounted at a car body, a base 200 provided at the center rail 100, a link arm 300 inserted into the base 200, a slider 400 connecting the link arm 300 and the sliding door of the car body to each other, and a latch part 500 limiting movement of the base 200, as shown in FIGS. 3 to 10.

As shown in FIGS. 3 to 6, since the center rail 100 is mounted at a side of a car body while having a linear shape, such that an indoor invasion amount of the center rail 100 is minimized as compared to a curved center rail according the related art, thereby making it possible to secure an indoor space and to improve the degree of freedom.

In certain embodiments of the disclosure, the center rail 100 has [symbol] shaped rail having outer walls formed at upper and lower portions thereof to enable a base 200 (described below) to be moved without departing from the center rail 100.

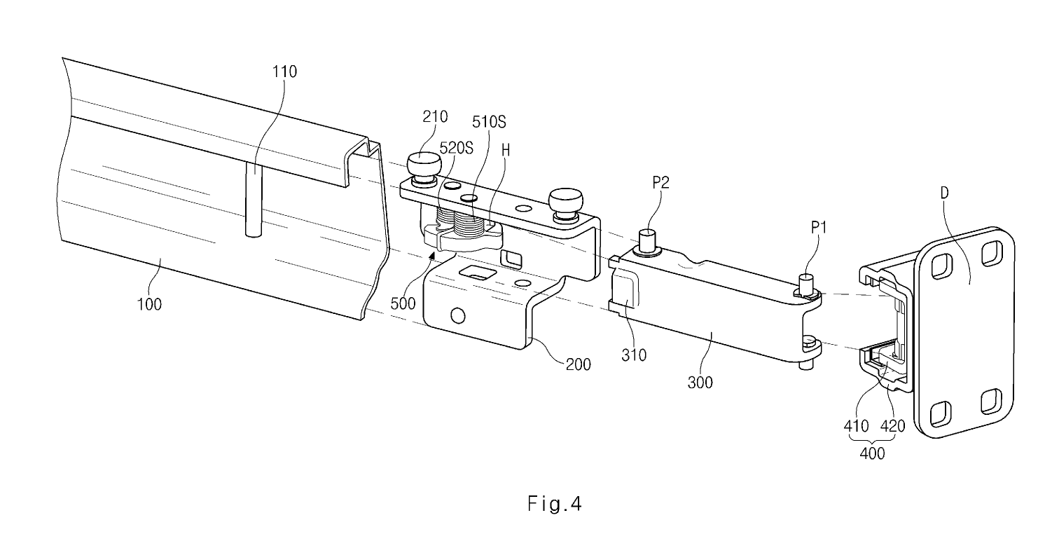

Meanwhile, the center rail 100 has a striker 110 formed vertically at a predetermined position in an inner side thereof as shown in FIG. 4, such that the striker 110 may be locked to a claw 520 of the latch part 500 (described below.)

The base 200, which is inserted into the center rail 100 to be movable in a length direction of the center rail 100, has a [symbol] shape and is moved along the center rail 100.

In a certain embodiment, the base 200 has a roller 210 rotatably provided on an upper portion of an outer side thereof. The roller 210 is received in the center rail 100 and roll-contacts thereto to facilitate movement of the base 210 along the center rail 100.

The link arm 300 has a pipe shape and has one end rotatably inserted into the base 200. At this end, a second pivot axis P2 is formed between the base 200 and the link arm 300 to enable the link arm 300 to be rotated, and a first pivot axis P1 is formed between the link arm 300 and a slider 400 (described below) to enable the slider 400 to be rotated.

The slider 400, which is rotatably connected to an other end of the link arm 300 connected to the base 200, has an outer side coupled to a coupling surface of the sliding door.

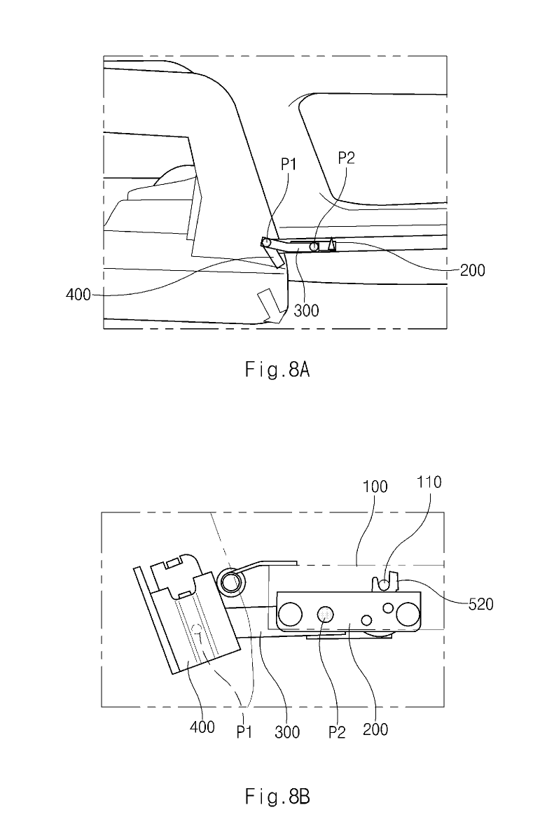

In this configuration, the slider 400 has an outer side slider 420 coupled to the sliding door and an inner side slider 410 slidably provided in the outer side slider 420 by a predetermined length and rotatably connected to the link arm 300, as shown in FIGS. 4 to 6, such that the inner side slider 410 is slid from the outer side slider 420 at an initial opening of the sliding door, thereby making it possible to pop up at the time of opening the sliding door, as shown in FIGS. 8A and 8B. Meanwhile, the outer side slider 420 has a locking part (not shown) formed at an inner side surface thereof to thereby prevent the inner side slider 410 from being separated from the outer side slider 420 when the inner side slider 410 is slid.

The latch part 500 is provided at an inner side of the base 200 to limit a movement of the base 200 along the center rail 100. The latch part 500 comprises a pawl 510 and a claw 520.

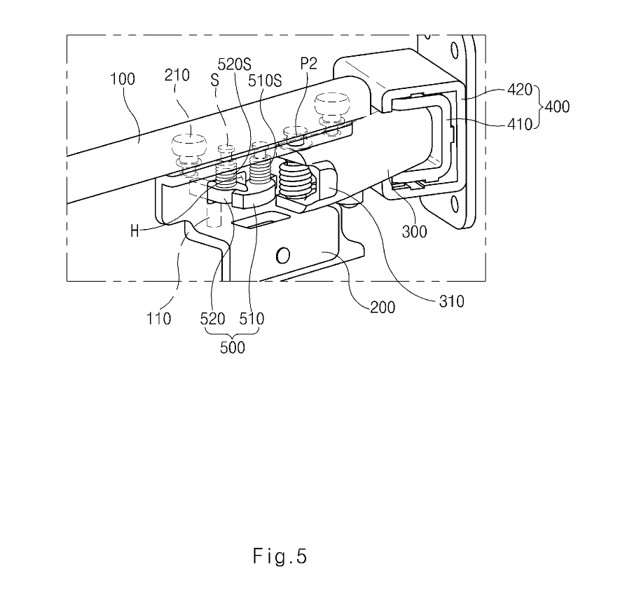

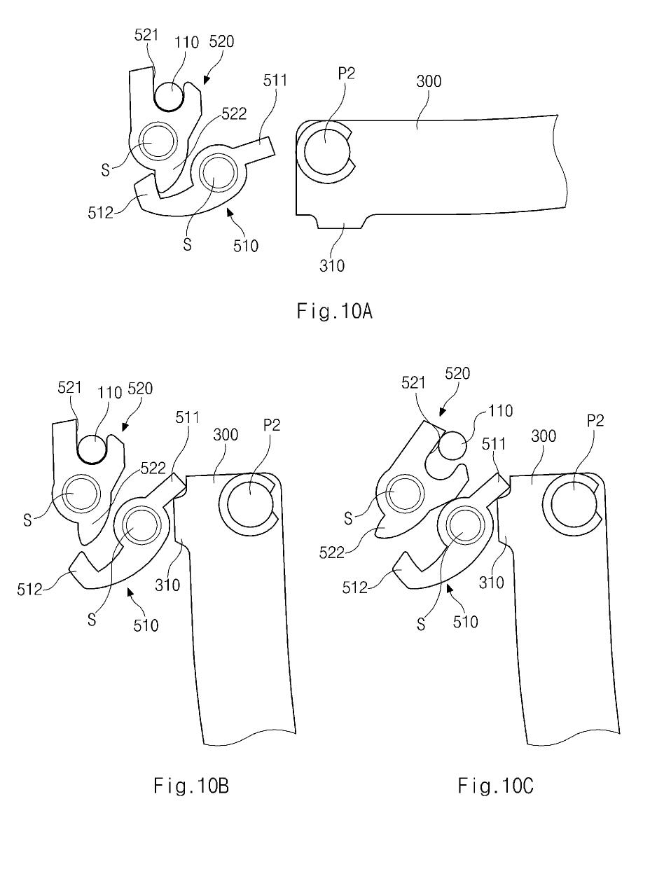

As shown in FIGS. 5, 10A, 10B, and 10C, the pawl 510 is provided at base 200 to be rotatable through a shaft S and has a lock protrusion 511 formed to be protruded at one end thereof, such that it is selectively locked to or unlocked from a protrusion part 310 of the link arm 300 (described below) according to the rotation of the link arm 300.

The protrusion part 310 is formed at an outer side lower portion of one end of the link arm 300 as shown in FIGS. 5, 6, 7A, 7B, 10A, 10B, and 10C, such that it may be locked to the lock protrusion 511 of the pawl 510 when the link arm 300 is rotated.

As shown in FIGS. 10A, 10B, and 10C, the claw 520 is rotatably provided at the base 200, a lock groove 521 is formed at one end of the claw 520 to enable the claw to be locked to or unlocked from the striker 110 of the center rail 100, and an other end of the claw 520 is locked to the pawl 510 to be rotated together with the pawl 510 when the pawl 510 is rotated.

In this configuration, in order to enable the lock groove 521 of the claw 520 to be locked to or unlocked from the striker 110 formed at the center rail 100, a hole H is formed at a rear surface of the base 200 and one end of the claw 520 having the lock groove 521 formed thereon is protruded into the rear surface of the base through the hole H, such that the lock groove 521 of the claw 520 may be locked to or unlocked from the striker 110 of the center rail 100 according to the rotation.

Meanwhile, a first locking part 512 is formed at the other end of the pawl 510 and a second locking part 522 detachably locked to the first locking part 512 is formed at the other end of the claw 520, such that when the first locking part 512 is rotated at the time of rotating the pawl 510, the second locking part 522 locked to the first locking part 512 is rotated to finally enable the claw 520 to be rotated.

In addition, as shown in FIGS. 4 to 6, the pawl 510 and claw 520 are mounted through the shaft S provided at the base 200, and springs 510S and 520S are provided between the pawl 510 and the shaft S, and between the claw 520 and the shaft S.

Meanwhile, in a state in which the sliding door is closed, the lock groove 521 of the claw 520 is locked to the striker 110 and the first locking part 512 of the pawl 510 maintains a state of being locked to the second locking part 522 of the claw 520 as shown in FIG. 10A. In this case, the pawl 510 and the claw 520 are not affected by elastic force by the springs 5105 and 520S. In an initial step of opening the sliding door, the slider 400 rotates the link arm 300 while being rotated, thereby rotating the pawl 510, as shown in FIG. 10B and in a step of opening the sliding door, the sliding door is slid so that the state in which the pawl 510 and the claw 520 are rotated by the link arm 300 is maintained while having the elastic force, as shown in FIG. 10C. In this state, when the sliding door is closed, the link arm 300 is rotated to an original position and the link arm 300 is spaced from the pawl 510 as shown in FIG. 10A, such that the pawl 510 is rotated to the original position by recovering force of springs 510S and 520S and the claw 520 is locked to the striker 110.

Hereinafter, an operation and effect of the present disclosure will be described.

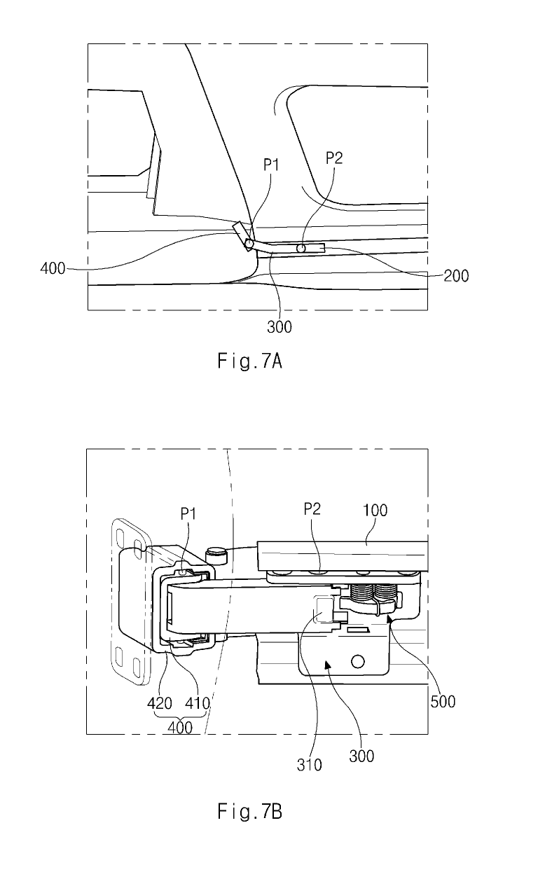

In a state in which the sliding door is closed, as shown in FIGS. 5, 7A, and 7B, the latch part 500 of the base 200 is locked and fixed to the striker 110 of the center rail 100 having the linear shape, the slider 400 is fixed to the sliding door, and the link arm 300 is maintained in a state in which it is connected to the slider 400 in a state in which it is rotatably inserted into the base 200.

In the present disclosure, although the center rail 100 has a linear shape, the link arm 300 inserted into the base 200 covers an end of the center rail 100, thereby making it possible to provide the linear-shaped center rail, not a curve shape center rail, in place of a curved portion of the center rail according to the related art. Therefore, an indoor invasion amount of the center rail is minimized, thereby making it possible to secure an indoor space and to improve a design appearance of a vehicle.

Meanwhile, the latch part 500 is provided at the base 200 in a state in which the lock groove 521 of the claw 520 is locked to the striker 110 of the center rail 100 to thereby disable the base 200 to be moved in a state in which the first locking part 512 of the pawl 510 and the second locking part 522 of the claw 520 are locked to each other, as shown in FIG. 10A.

In an initial state (POP-UP) in which the sliding door is opened, as shown in FIGS. 8A and 8B, the sliding door is popped up, such that the inner side slider 410 is slid from the outer side slider 420 connected to the sliding door to thereby prepare an opening.

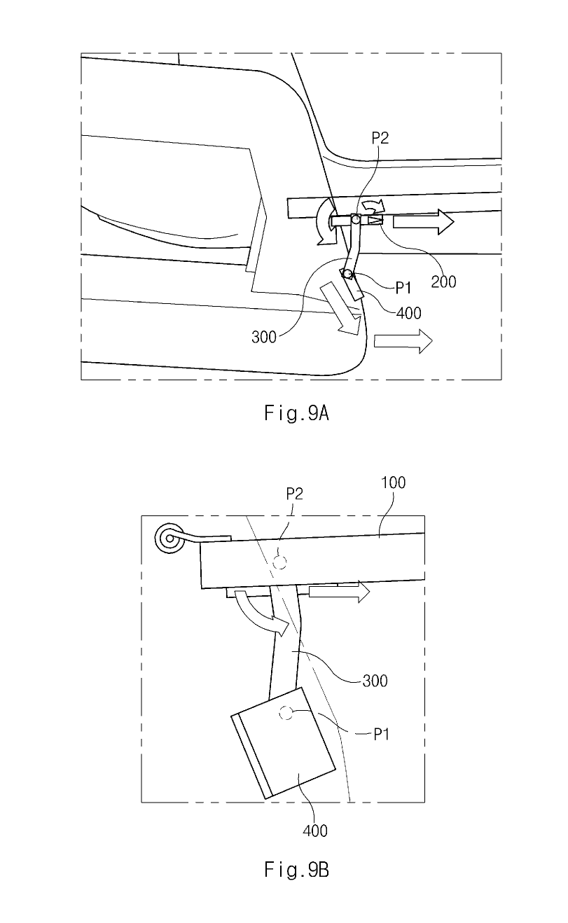

In a state (SLIDING) in which the sliding door is opened, as shown in FIGS. 9A and 9B, the sliding door is opened, such that the slider 400 rotates the link arm 300 connected to the base 200 by the second pivot axis P2 to rotate the latch part 500 (see FIGS. 10A, 10B, and 10C) locked to the link arm 300, such that the elastic force is accumulated on the springs 5105 and 520S provided at the pawl 510 and the claw 520, latching of the base 200 and the center rail 100 is released, the link arm 300 and the base 200 become vertical to each other, and the base 200 is moved along the center rail 100 by force opening the sliding door, thereby completing the opening of the sliding door.

In this case, as shown in FIG. 10C, the latching release of the base 200 and the center rail 100 allows the protrusion part 310 to rotate the pawl 510 of the latch part 500 by the rotation of the link arm 300. When the pawl 510 is rotated, the claw 520 linked to the pawl 510 is also rotated to thereby generate a clearance between the lock groove 521 of the claw 520 and the striker 110 of the center rail 100, such that the latching of the base 200 and the center rail 100 is released in a state having elastic force. In this state, when the sliding door is opened, since the link arm 300 moves the pawl 510 to a left direction on FIG. 10C, the claw 520 is also moved, such that the claw 520 is unlocked from the striker 110. As a result, the base 200 may be moved along the center rail 100.

Meanwhile, the closing of the sliding door is performed in a sequence reverse to that of the opening of the sliding door. In the case of closing the sliding door, when the sliding door is closed in the state of FIG. 10C, the link arm 300 is moved to a right direction on FIG. 10C, the claw 520 separated from the striker 110 is locked to the striker 110, the base 200 is fixed, and then the link arm 300 is rotated. In this state, when the sliding door is completely closed, the link arm 300 is separated from the latch part 500 and the claw 520 of the latch part 500 is completely locked to the striker 110 by the accumulated recovering force of the spring 520S, as shown in FIG. 10A.

As described above, according to the exemplary embodiment of the present disclosure, an indoor invasion amount of the center rail is minimized, thereby making it possible to secure an indoor space, the linear center rail is used, thereby making it possible to improve a design of a vehicle, and the link structure is provided, thereby making it possible to improve operability of opening and closing of the sliding door.

As described above, although the present disclosure has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. A linear center rail link structure of a sliding door for a vehicle, the linear center rail link structure comprising:
a linear-shaped center rail mounted at a side of a car body corresponding to the sliding door of the vehicle and having a striker formed at a predetermined position in a vertical direction;
a base configured to be moveable in a length direction along the center rail;
a link arm having one end rotatably inserted into the base;
a slider rotatably connected to an other end of the link arm and having an outer side surface coupled to the sliding door; and
a rotatable latch part provided at the base to be locked to or unlocked from the striker.

2. The linear center rail link structure according to claim 1, wherein the slider includes:
an outer side slider coupled to the sliding door; and
an inner side slider slidably provided in the outer side slider by a predetermined length and rotatably coupled to the other end of the link arm.

3. The linear center rail link structure according to claim 1, wherein the latch part includes a pawl rotatably provided at the base to be locked to or unlocked from the link arm, and a claw rotatably provided at the base to be locked to or unlocked from the striker.

4. The linear center rail link structure according to claim 3, wherein the pawl has a lock protrusion formed at one end thereof to be selectively locked to or unlocked from the link arm, and
one end of the claw is provided with a lock groove so as to be locked to or unlocked from the striker and an other end of the claw is locked to the pawl so as to be rotatable.

5. The linear center rail link structure according to claim 4, wherein an other end of the pawl is provided with a first locking part and the other end of the claw is provided with a second locking part locked to or unlocked from the first locking part.

6. The linear center rail link structure according to claim 4, wherein a lower portion of one end of the link arm, locked to or unlocked from the lock protrusion of the pawl, is provided with a protrusion part.
